(19) United States
(12) Patent Application Publication
(10) Pub. No.: US 2021/0189760 A1
(43) Pub. Date: Jun. 24, 2021

(54) BARRIER REINFORCEMENT

(71) Applicant: Evelyn Andra Whitworth, Tulsa, OK (US)

(72) Inventor: Evelyn Andra Whitworth, Tulsa, OK (US)

(21) Appl. No.: 17/132,861

(22) Filed: Dec. 23, 2020

Related U.S. Application Data
(60) Provisional application No. 62/953,313, filed on Dec. 24, 2019.

(51) Int. Cl. E04H 17/16

(52) U.S. Cl. CPC E04H 17/163

(57) ABSTRACT

A modular reinforcement system for reinforcing barriers comprising panels that can be hingedly connected to one another and to an underlying barrier in various configurations. The panels can be used for covering gaps to prevent the ingress or egress of animals through the gaps or openings. The panels are modular in nature, and multiple panels can be attached in various configurations to cover as much or little of a barrier as needed. The panels can be easily installed, moved, and removed, permitting ease of access to the barriers and surfaces behind them.

### BACKGROUND

Many existing barriers need to be reinforced for a variety of reasons, such as to fill gaps under and between components, to reinforce compromised components, or to prevent animals from passing through, under, or around the barrier. A need exists for a modular reinforcement system that is adaptable to a variety of configurations and uses, can be easily used, maintained, and installed, and provides ready access to the barrier and its surroundings.

### SUMMARY

This disclosure is directed to a modular reinforcement system for fences, barriers, enclosures and other structures. The modular reinforcement system includes a first panel and a second panel, wherein the first panel is hingedly connected to the second panel, and wherein the first panel is capable of being hingedly connected to an external barrier or surface.

### BRIEF DESCRIPTION OF THE DRAWINGS

The foregoing summary as well as the following detailed description will be better understood when reviewed in conjunction with the appended drawings. It should be understood that the invention is not limited to the precise arrangements and instrumentalities shown. Further, the components in the drawings are not necessarily to scale and do not depict all potential variations of the claimed invention. In some drawings, certain components have not been portrayed in detail so as not to obscure the related relevant feature being depicted.

FIG. 1 is front perspective view of an exemplary arrangement of the modular reinforcement system.

FIG. 2 is a front perspective view of an exemplary arrangement of the modular reinforcement system.

FIG. 3 is a partial view of the exemplary arrangement of the modular reinforcement system as depicted in FIG. 1 detailing a hinged connection between the panels.

FIG. 4 depicts a partial exploded view of the exemplary arrangement of the modular reinforcement system as depicted in FIG. 2, detailing a hinged connection between the panels.

FIG. 5 depicts a front perspective view of a coiled wire used to create the hinged connection depicted in FIG. 1.

FIG. 6 depicts a bottom perspective view of a coiled wire used to create the hinged connection depicted in FIG. 1.

FIG. 7 depicts a side perspective view of a coiled wire used to create the hinged connection depicted in FIG. 1.

FIG. 8 depicts a bottom perspective view of a coiled wire used to create the hinged connection depicted in FIG. 1.

FIG. 9A depicts an exemplary barrier installed on a surface.

FIG. 9B depicts an exemplary arrangement of the modular reinforcement system installed on a barrier.

FIG. 9C depicts an exemplary arrangement of the modular reinforcement system installed on a barrier, detailing the movement of the panels from a first position depicted in FIG. 9B to a second position depicted in FIG. 9C.

FIG. 10A is a partial view of an exemplary modular reinforcement system installed on a barrier, detailing a hinged connection between a panel and a barrier.

FIG. 10B is a partial view of an exemplary modular reinforcement system installed on barrier, detailing a hinged connection between a panel and a barrier.

FIG. 11A is a partial view of an exemplary modular reinforcement system installed on a barrier, detailing a connection between a panel and a surface.

FIG. 11B is a partial view of an exemplary modular reinforcement system installed on a barrier, detailing a connection between a panel and a surface.

### DETAILED DESCRIPTION

The present disclosure may be understood more readily by reference to the figures and the following detailed description. In some instances, numerous specific details are set forth in order to provide a thorough understanding of the invention described herein. However, those of ordinary skill in the art will understand that the invention described herein can be practiced without these specific details. In other instances, methods, procedures and components have not been described in detail so as not to obscure the related relevant feature being described.

The present disclosure concerns a movable, modular reinforcement system for fences, barriers, enclosures, structures, or other similar isolating devices, all of which are referred to herein as a barrier. The modular reinforcement system can be used to reinforce and cover gaps in and around such barriers. As used herein, and unless otherwise specified, the word “gap” includes, but is not limited to, voids, openings, holes, slits, breaches, apertures, and all synonyms thereof, and any other openings that might allow for the unwanted ingress or egress of animals.

Existing alternatives for repairing and reinforcing barriers are cumbersome, difficult to install, require specialized tools, and/or must be cut to fit the area of concern. When installed, these existing alternatives block access to the underlying barrier and/or the surface on which the barrier is installed, preventing the user from conducting routine maintenance without first removing or partially removing the reinforcement. The present disclosure provides a moveable, modular system that is easy to install using ordinary household tools. The modular nature of the system enables the user to combine various components of the system as needed, without first cutting the components to fit the area of concern. The modular nature of the system further permits the user to utilize only those components necessary for the particular application. The modular nature of the system permits the system to address a variety of gaps in, under and around barriers. The hinged connections between the panels of the modular system and the panels of the modular system and the underlying barrier permit a user to easily and quickly access the underlying barrier or surface for maintenance and repair without first removing or partially removing the components installed in unaffected areas.

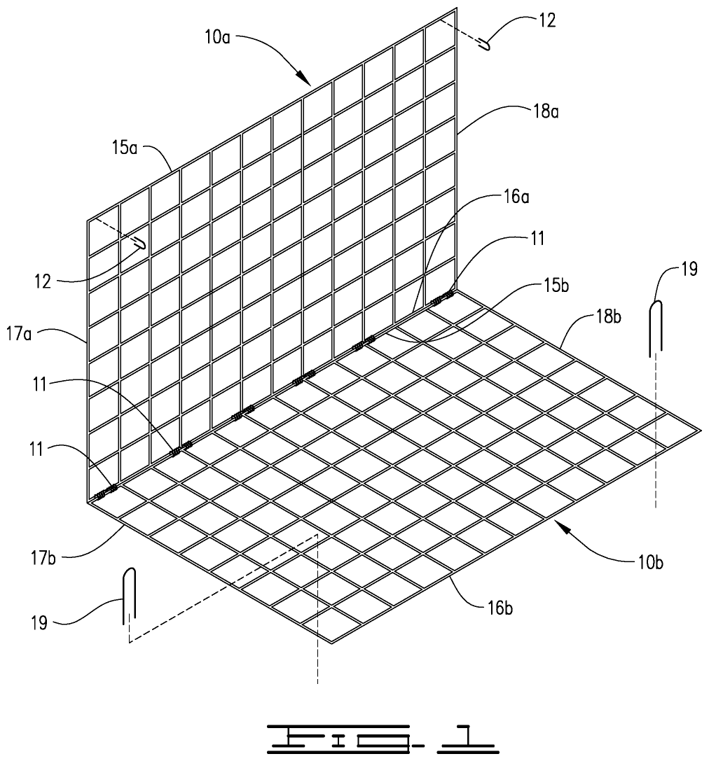

As depicted in FIG. 1, the modular reinforcement system includes two or more panels 10, at least one coiled wire 11, and a staple 12. Each panel 10 has a front surface, a back surface, a top edge 15, a bottom edge 16, a first side 17 and a second side 18.

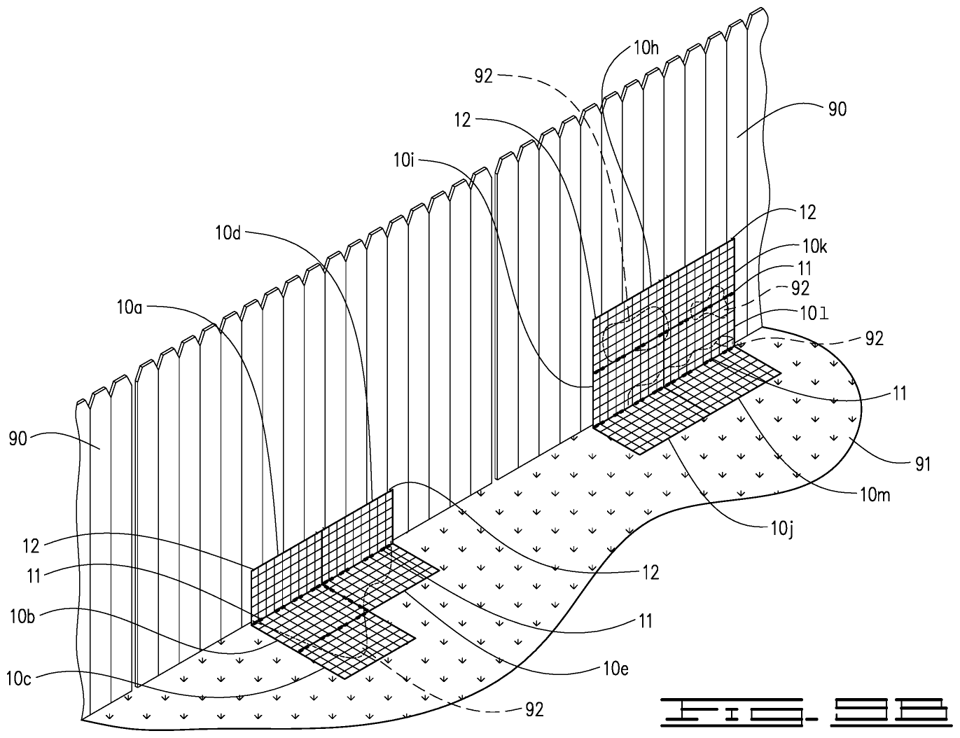

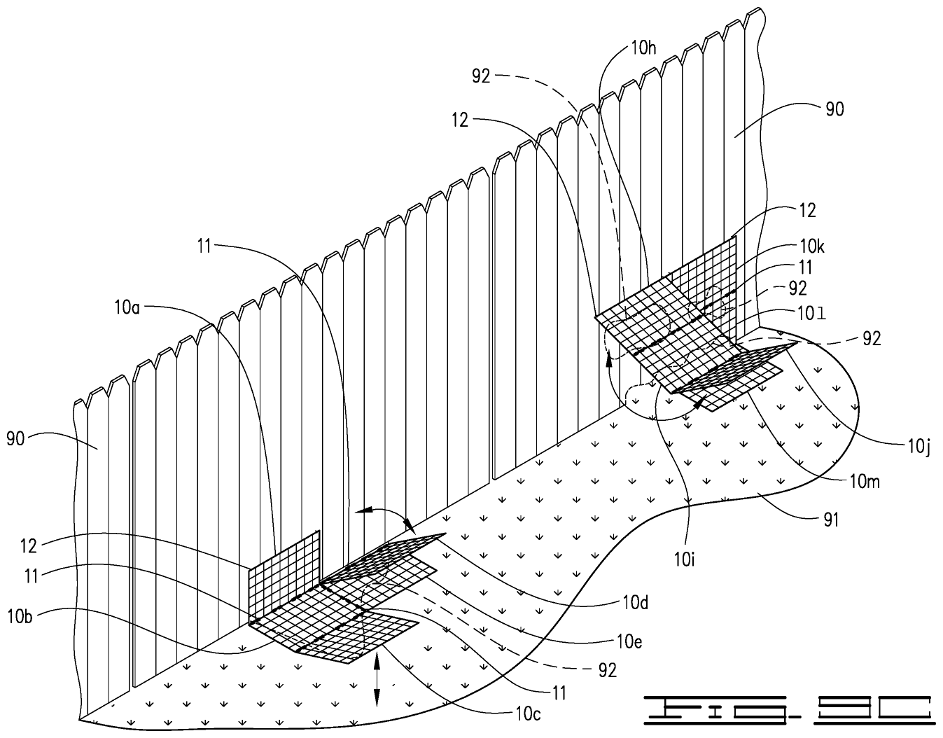

FIG. 1 depicts a first panel 10a that is hingedly connected to a second panel 10b. In the depicted arrangement, bottom edge 16a of panel 10a is hingedly connected to top edge 15b of panel 10b by coiled wires 11. Although FIG. 1 depicts two panels connected in a vertical arrangement in which sides 17a and 18a of panel 10a are substantially aligned with sides 17b and 18b of panel 10b, an unlimited number of additional panels may be hingedly connected to one another in a variety of configurations depending upon the needs of the user. For example, as depicted in FIG. 9B, panel 10b is hingedly connected to panel 10a, panel 10c, and panel 10e. The hinged connection between a first panel 10 and a second panel 10 allows a range of motion of the first panel about the hinged connection relative to the second panel of at least 90 degrees, preferably 180 degrees, and, in some embodiments, approximately 360 degrees.

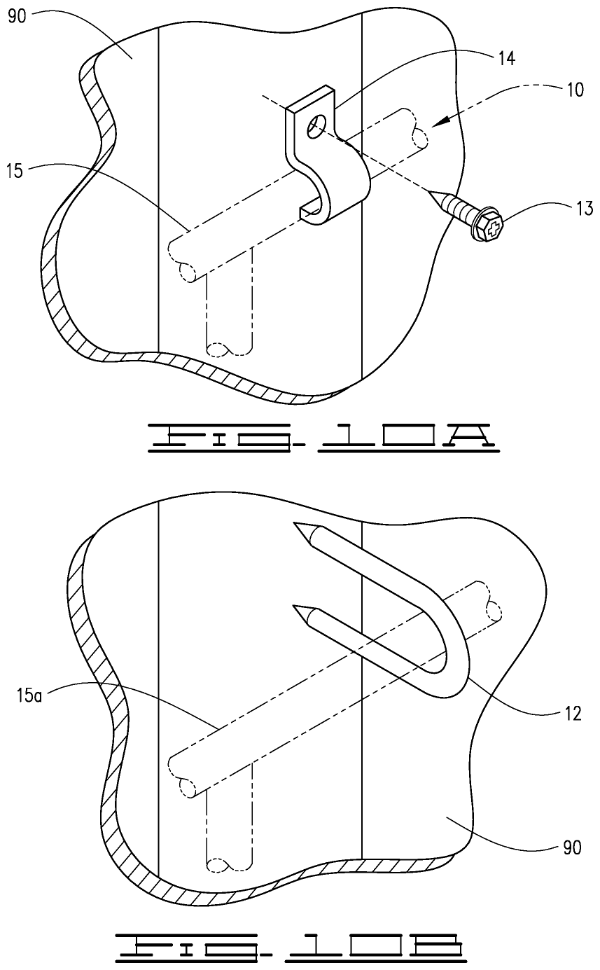

As shown in FIG. 1 and illustrated further in FIG. 10B, staple 12 may be used to connect one or more panels 10 to an external barrier 90. In the figures, staple 12 is substantially U-shaped. Staple 12 may take any shape suitable to secure one or more panels 10 to external barrier 90. In FIGS. 1 and 10B, panel 10a is arranged such that top edge 15a of panel 10a contacts external barrier 90. Staple 12 partially surrounds top edge 15a of panel 10a while engaging barrier 90, forming the hinged connection between panel 10a and barrier 90.

FIG. 10A depicts an example of the modular reinforcement system in which the hinged connection between a panel 10 and barrier 90 is formed by one or more screws 13 and one or more brackets 14. As depicted in FIG. 10A, panel 10 is arranged such that top edge 15 of panel 10 contacts external barrier 90. Bracket 14 is substantially U-shaped. Bracket 14 engages and partially surrounds top edge 15 of panel 10, such that bracket 14 contacts barrier 90 on either side of the top edge 15 of panel 10. Screw 13 passes through bracket 14 to engage barrier 90, creating the hinged connection between panel 10 and barrier 90. As will be evident to one of skill in the art, a variety of mechanisms, including but not limited to hinges, U-bolts, U-connectors staples, cable ties, chains, nails, hooks, screws, hooks and eyes, eyescrews, clamps, ties, rings, clasps, or other fastening devices known in the art may be used to hingedly connect one or more panels 10 to barrier 90 depending upon the application and the composition of the barrier.

The hinged connection between a panel 10 and barrier 90 allows a range of motion of the first panel about the hinged connection relative to barrier 90 of at least 90 degrees, preferably 180 degrees, and, in some embodiments, approximately 360 degrees.

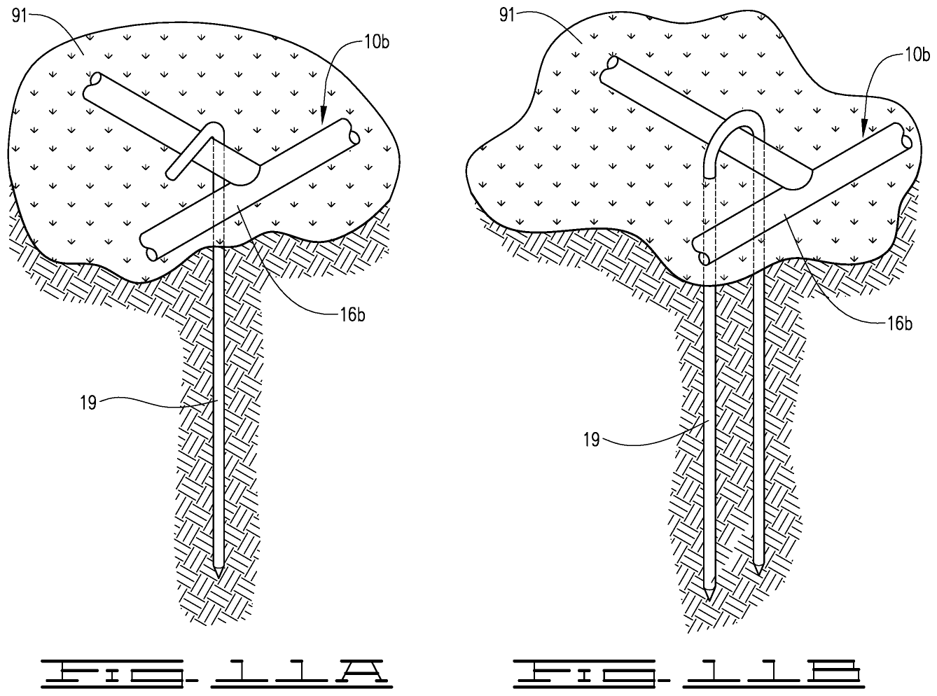

As shown in FIG. 1 and illustrated further in FIGS. 11A and 11B, a stake 19 may be used to secure one or more panels 10 to a surface 91. As depicted in FIG. 1 and as further detailed in FIG. 11B, panel 10b is arranged such that panel 10b contacts surface 91. As shown in FIGS. 1 and 11B, stake 19 engages and partially surrounds the bottom edge 16b of panel 10b, such that stake 19 engages surface 91 on either side of bottom edge 16b of panel 10b. Although stake 19 is depicted as substantially U-shaped in FIGS. 1 and 11B, it will be evident to one of skill in the art that stake 19 can be any shape that would enable stake 19 to secure a panel 10 to surface 91. For example, as shown in FIG. 11A, stake 19 may be substantially L-shaped. Although the figures depict stake 19 as being located at the bottom edge 16b of panel 10b, it will be evident to one of skill in the art that the stake 19 may be placed in any location in which it engages both panel 10 and surface 91. It will further be evident to one of skill in the art that, although the figures depict panels 10 being secured by stakes 19, panels 10 can also be secured to surface 91 by any suitable mechanism, including anchors, weights, staples, nails, hooks, screws, hooks and eyes, eyescrews, clamps, ties, rings, clasps, or other fastening devices known in the art. The mechanism for securing a panel 10 to a surface 91 can be integrated with or separate from the panel 10. In one example, the weight of the panel 10 alone is sufficient to secure the panel 10 to surface 91.

As depicted in FIG. 1 and further illustrated by FIGS. 3 and 9B, the hinged connection between panels 10 may be created by a component that is separate from panels 10. For example, as shown in FIGS. 1 and 3, the panels 10 may be hingedly connected by coiled wire 11. As shown in detail in FIG. 3, coiled wire 11 engages and wraps around both the bottom edge 16a of panel 10a and the top edge 15b of panel 10b, forming a hinged connection between panel 10a and panel 10b. The coiled wire 11 can be made of metal, a combination of metal and plastic, or any suitable material that would allow the coiled wire 11 to engage and create a hinged connection between panel 10a and panel 10b. While FIGS. 1, 3, and 9B depict a hinged connection formed by a coiled wire 11, it will be evident to one of skill in the art that the hinged connection may also include any structural component capable of hingedly connecting one or more panels 10, including but not limited to a ring, a chain, a cable tie, a clamp, a clasp, or any other device suitable for forming a hinged connection between one or more panels 10.

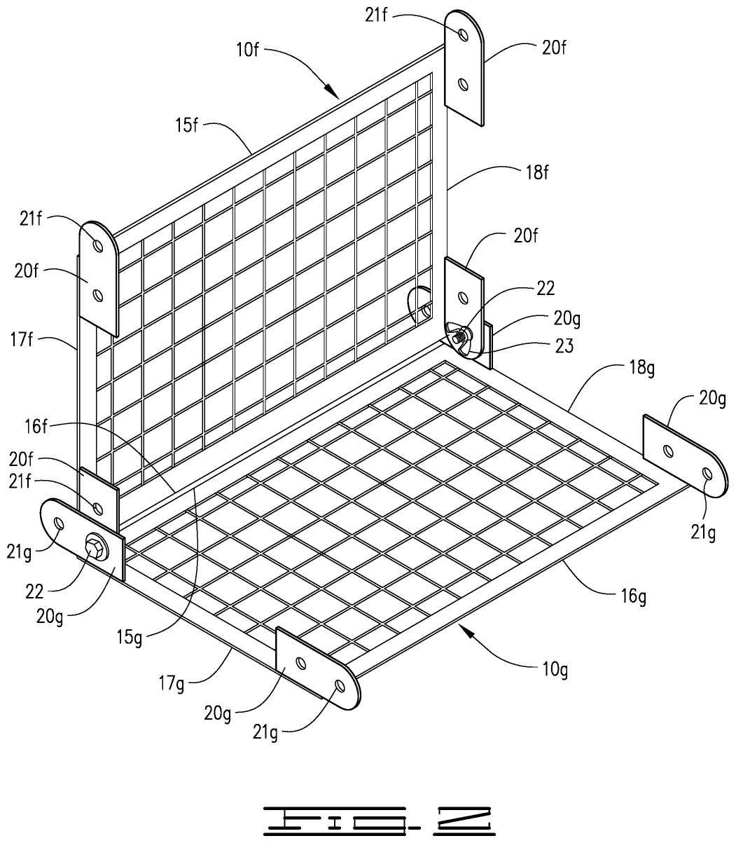

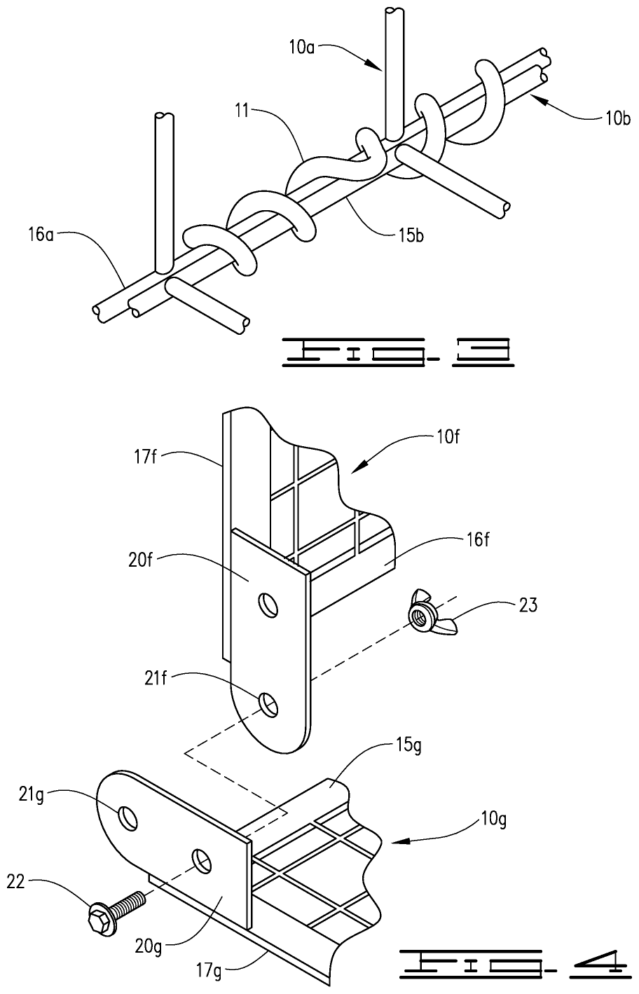

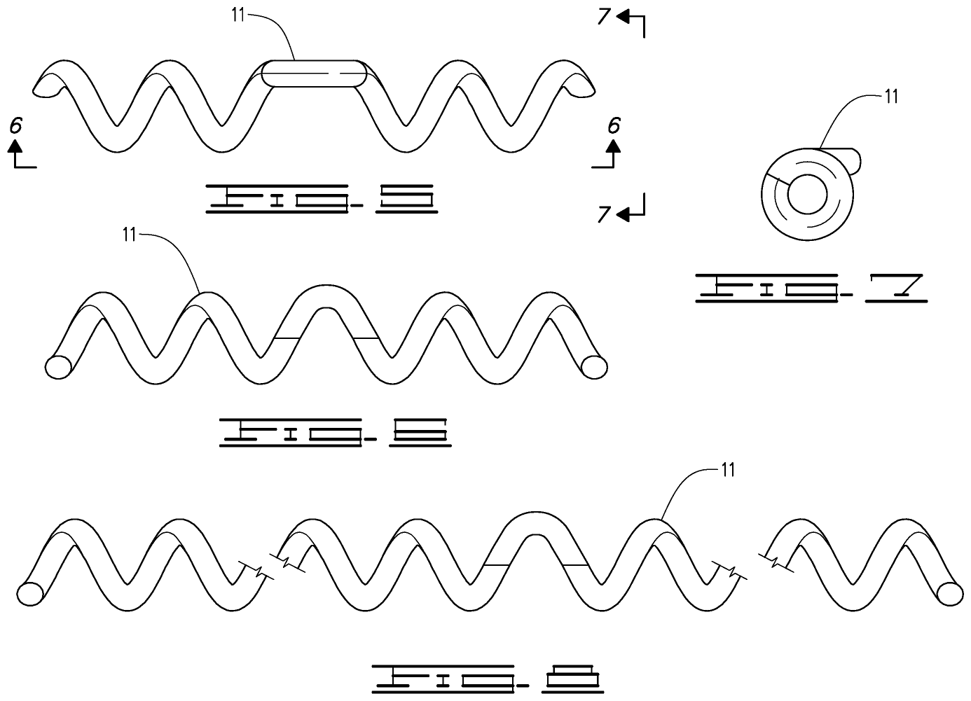

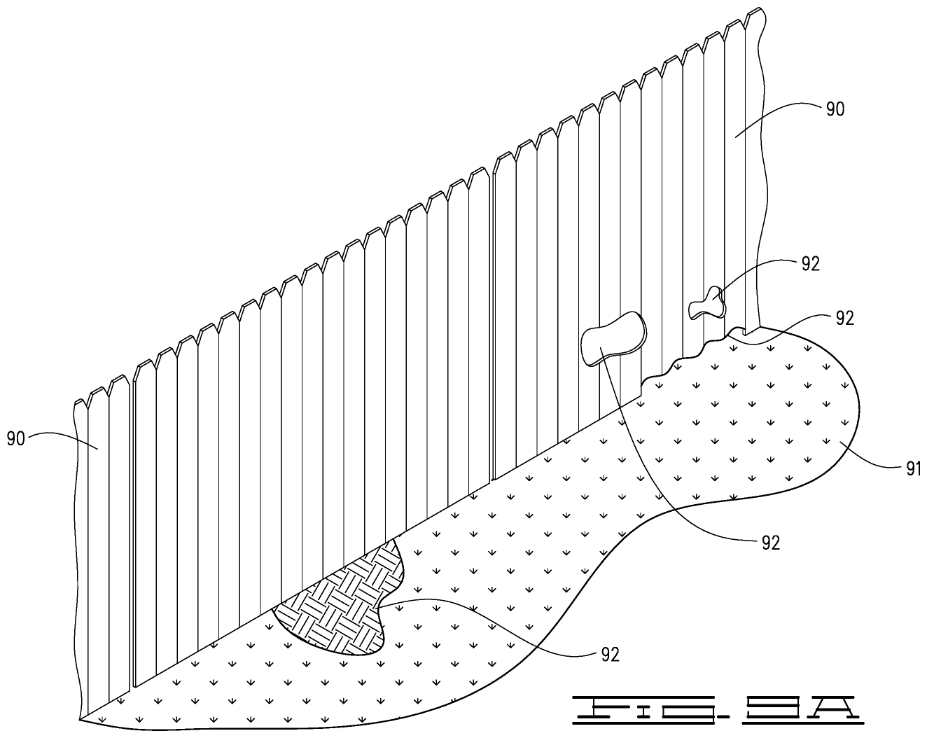

FIGS. 2 and 4 illustrate another hinged connection between the panels 10. In the figures, the modular reinforcement system includes two or more panels 10, screw 22 and nut 23. As shown in FIG. 2, panel 10f has a top edge 15f, a bottom edge 16f, a first side 17f, a second side 18f, and at least one tab 20f having at least one hole 21f disposed therein. Panel 10g has a top edge 15g, a bottom edge 16g, a first side 17g, a second side 18g, and at least one tab 20g having at least one hole 21g disposed therein. As depicted in the figures, each tab 20 may be located approximately at or near the top edge 15 or the bottom edge 16 of panel 10.

As depicted in FIG. 2, panels 10f and 10g are aligned such that at least one hole 21f of at least one tab 20f of panel 10f is aligned with at least one hole 21g of at least one tab 20g of panel 10g. As illustrated in FIG. 2 and FIG. 4, screw 22 passes through hole 21g, hole 21F, and nut 23, completing the hinged connection between panel 10f and 10g. Although the figures depict the hinged connection as being formed in part by tabs 20 integrated with the panels 10, it will be evident to one of skill in the art that any one of a number of alternative integrated components, such as a tube or a ring, could be used to form part of the hinged connection between panels 10. Similarly, although the figures depict a hinged connection between the panels 10 formed in part by screw 22 and nut 23, it will be evident to those of skill in the art that the hinged connection could be completed by any one of a number of alternatives, including, for example, a pin, a chain, a cable tie, or any other mechanism capable of completing the hinged connection between the panels 10.

The panels 10 are movable and modular, such that they can be arranged in a variety of configurations depending upon the barrier with which they are used. Although the figures depict panels 10 made primarily out of wire arranged in a grid, panels 10 can be manufactured from any material suitable for a particular application. The degree of rigidity of panels 10 may vary from application to application. Accordingly, panels 10 may be manufactured from a plurality of materials including, but not limited to: a rigid metal, hard plastic mesh, flexible metal or plastic mesh, a synthetic mesh or netting, or combinations thereof. In certain instances, it may be desirable for the panels 10 to have a rigid frame on the top, bottom, and sides of the panels 10, while the interior of the panels 10 is composed primarily of a mesh or netting, as depicted in FIG. 2.

One or more types of panels 10 can be used in combination, allowing the system to be adapted for use in connection with a variety of terrains, surfaces, and barriers, as well as for the containment or exclusion of a variety of animals. The panels 10 may have a height of 7.5 inches and a width of 18 inches. In another example, the panels 10 have a height of 6 inches and a width of 18 inches. In still another example, the panels 10 have a height of 6 inches and a width of 24 inches. In yet another example, the panels 10 have a height of 7.5 inches and a width of 24 inches.

As shown in FIG. 9A through 9C, the panels 10 can be connected and utilized in a variety of ways. FIG. 9A depicts a barrier 90 installed on surface 91, wherein the barrier 90 and surface 91 have gaps 92. FIG. 9B shows an exemplary arrangement of panels 10 in which panels 10a through 10e and panels 10h through 10m have been arranged to cover gaps 92. In FIG. 9B, panel 10b is hingedly connected to panels 10a, 10c, and 10e. Panel 10d is hingedly connected to panel 10e. Panel 10i is hingedly connected to panels 10h and 10j. Panel 10l is hingedly connected to panel 10k and panel 10m.

As shown in the figures, panels 10 may be hingedly connected to barrier 90. In FIG. 9B, panels 10a, 10d, 10h and 10k are hingedly connected to barrier 90 by staples 12. The hinged connections between the panels 10, and the hinged connections between the panels 10 and barrier 90, enable movement of the panels 10 from a first position depicted in FIG. 9B to a second position depicted in FIG. 9C. For example, the hinged connection between panel 10b and panel 10c allows a user to lift panel 10c from a first position in FIG. 9B to a second position in FIG. 9C without impacting panels 10a and 10b. The hinged connections between panels 10h and 10i, between panels 10i and 10j, and between panel 10h and barrier 90 enable a user to lift panels 10h, 10i and 10j from a first position depicted in FIG. 9B to a second position depicted in FIG. 9C. As demonstrated by FIGS. 9B and 9C, the hinged connection between panels 10 enable the user to access barrier 90 and surface 91.

The hinged connection between two panels 10 and the hinged connection between a panel 10 and a barrier 90 may be disassembled by hand to allow access to barrier 90 or surface 91 without impacting other panels 10. For example, in FIG. 9C, the staples 12 have been removed from panel 10d, allowing panel 10d to be moved from a first position depicted in FIG. 9B to a second position in FIG. 9C. This enables the user to easily access the underlying barrier 90 and surface 91 for purposes such as maintenance and repair without impacting the components installed in unaffected areas.

The modular nature of the panels 10 allows for simple and customizable installation. The modular nature of the panels 10 further allows for a single panel 10 or multiple panels 10 to reinforce a limited area, or for multiple panels 10 in combination to reinforce a larger area.

In addition to combining panels 10 in the manner depicted in the figures, multiple panels 10 can be placed or connected side-by-side to cover a given length of a barrier 90 or surface 91. Additional panels 10 can be placed so as to cover as much or little of surface 91 or barrier 90 as necessary.

While various aspects, implementations, structures, devices, systems, methods, and techniques for the disclosed modular reinforcement system have been described and/or illustrated herein, such descriptions and illustrations are presented by way of example and are not to be limited to the precise descriptions and illustrations. Accordingly, numerous modifications and variations are possible by those skilled in the art without departing from the spirit and scope hereof, as defined by the following and later-submitted claims and their equivalents. As such, the foregoing description merely enables and describes the general uses and methods of the present invention. The breadth and scope of the present disclosure should not be limited by any of the implementations and illustrations described herein, but should be defined only in accordance with the following and later-submitted claims and their equivalents. Accordingly, the following claims define the true scope of the present invention.

What is claimed is:

1. A movable and modular reinforcement system comprising:
a first panel having a front surface, a back surface, and four sides, and a second panel having a front surface, a back surface, and at least one side, wherein said first panel is hingedly connected to said second panel.

2. The system of claim 1 further comprising a coiled wire, wherein said coiled wire is positioned to engage and wrap around at least one side of said first panel and at least one side of said second panel, thereby hingedly connecting said first panel and said second panel.

3. The system of claim 1 further comprising a wire ring, wherein said wire ring is positioned to engage and wrap around at least one side of said first panel and at least one side of said second panel, thereby hingedly connecting said first panel and said second panel.

4. The system of claim 1, further comprising a U-bolt, wherein said U-bolt hingedly connects said first panel to an external barrier.

5. The system of claim 1, further comprising a stake, wherein said stake removably secures said second panel to an external surface.

6. The system of claim 1 wherein at least one of said first or second panels is comprised of a mesh material.

7. The system of claim 6 wherein said mesh material is flexible.

8. The system of claim 6 wherein said mesh material is comprised of metal or hard plastic.

9. The system of claim 1 wherein said first panel is between 6 and 7.5 inches in height and 18 and 25 inches in width.
